(19) United States
(12) Patent Application Publication
(10) Pub. No.: US 2017/0248012 A1
(43) Pub. Date: Aug. 31, 2017

(54) IMAGING SUBTERRANEAN ANOMALIES USING ACOUSTIC DOPPLER ARRAYS AND DISTRIBUTED ACOUSTIC SENSING FIBERS

(71) Applicant: HALLIBURTON ENERGY SERVICES, INC., Houston, TX (US)

(72) Inventors: Burkay Donderici, Houston, TX (US); Paul Rodney, Spring, TX (US); Joseph Young, Houston, TX (US)

(73) Assignee: HALLIBURTON ENERGY SERVICES, INC., Houston, TX (US)

(21) Appl. No.: 15/507,706

(22) PCT Filed: Jul. 30, 2015
(86) PCT No.: PCT/US15/42811

§ 371 Date: Feb. 28, 2017

(51) Int. Cl. E21B 49/00; G01V 1/42

(52) U.S. Cl. CPC E21B 49/00; G01V 1/42; E21B 47/123

(57) ABSTRACT

A system to obtain information about a subsurface formation, in some embodiments, comprises an array of acoustic transmitters in a first well; a distributed acoustic sensing (DAS) fiber in a second well; and processing logic, in communication with the array of acoustic transmitters and the DAS fiber, that activates the array of acoustic transmitters and the DAS fiber so as to use the Doppler effect to obtain information about the subsurface formation.

### BACKGROUND

Understanding the structure and material properties of the geological formation surrounding a wellbore provides valuable information for oil and gas field development. Particularly helpful in this regard are techniques that facilitate the visualization of subterranean anomalies, such as hydrocarbon deposits and water sources. Several such techniques have been used with varying degrees of success, but virtually all of them suffer from an inability to obtain high-resolution images of anomalies positioned deep below the Earth's surface. This difficulty is generally a function of the low frequencies that must be used in seismic imaging applications. Such low-frequency signals tend to have magnitudes and phases that differ from each other only very slightly, resulting in a blur effect whereby the subterranean features are difficult to distinguish from one another.

Imaging using the Doppler effect is one technique that potentially addresses this difficulty. However, Doppler methodologies require relative movement between signal receivers and the anomalies being imaged. That is, either the anomaly being imaged must be moving or the receiver implementing the Doppler technique must be moving within the wellbore. Anomalies, however, rarely move, and techniques that require receiver movement can be tedious and time-consuming. Accordingly, a relatively fast and efficient technique for high-resolution imaging of deep subterranean anomalies would be especially valuable.

### BRIEF DESCRIPTION OF THE DRAWINGS

Accordingly, there are disclosed in the drawings and in the following description various methods and systems for imaging subterranean anomalies using acoustic Doppler arrays. In the drawings:

FIG. 1 is a schematic of an illustrative drilling environment.

FIG. 2 is a schematic of an illustrative wireline environment.

FIG. 3 is a conceptual schematic of an illustrative vertical cross-well wireline environment.

FIG. 4 is a conceptual schematic of an illustrative vertical cross-well drilling and wireline environment.

FIG. 5 is a conceptual schematic of an illustrative horizontal cross-well wireline environment.

FIG. 6 is a conceptual schematic of an illustrative horizontal cross-well drilling and wireline environment.

FIG. 7 is a conceptual schematic of an illustrative well-to-surface environment.

FIG. 8 is a conceptual schematic of a cross-well and well-to-surface environment.

FIG. 9 is a conceptual schematic of a single-well environment.

FIGS. 10A-10F are schematics of illustrative transmitters and receivers.

FIG. 11 is a schematic of illustrative processing logic used to log data.

FIG. 12 is a schematic of illustrative, time-lapsed processing logic used to log data.

FIG. 13 is a schematic of illustrative processing logic using distributed acoustic sensing (DAS) to log data.

FIGS. 14A-14B are graphs of illustrative transducer array weighting signals as a function of time.

FIG. 15 is a data flow chart of an illustrative Doppler-enhanced inversion method for localization.

FIG. 16 is a data flow chart of an illustrative Doppler-enhanced inversion method for imaging.

FIG. 17 is a process flow chart of an illustrative Doppler-enhanced visualization method.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### NOMENCLATURE

The following terms and any derivatives thereof, when found in the specification, drawings or claims, should be interpreted as indicated:

“Measurement unit,” as used herein, denotes one or more transmitter antennas or one or more receiver antennas. For instance, a single transmitter antenna may be referred to as a measurement unit, as may an array of transmitter antennas.

“Effective movement” encompasses both physical movement of a transmitter (e.g., by lowering a sonde or drilling deeper into a formation) and the sequential activation of consecutive transmitters or receivers in an array so as to emulate physical movement.

“Processing logic” is a broad term and encompasses any and all processors, computers, and/or other types of circuitry that help to implement the techniques described herein.

“Activated” means that the transmitter or receiver in question is powered on while its default state is to be powered off. For instance, an “activated” transmitter T₁ means that although T₁ defaults to being powered off, it is temporarily powered on for the purpose of transmitting a signal. The term also may mean that the transmitter or receiver in question is always powered on, but that its signal—whether being transmitted or received—is assigned a greater weight than signals being handled by the other transmitters or receivers in the same array of transmitters or receivers.

### DETAILED DESCRIPTION

Disclosed herein are methods and systems for collecting information pertaining to subterranean anomalies using the Doppler effect. The disclosed techniques are generally directed to one or more arrays of acoustic transducers disposed in the vicinity of a subterranean anomaly. A Doppler effect is emulated by triggering the transducers in sequence to simulate motion of an acoustic source and/or motion of an acoustic receiver. That is, the transmitters in the array of transmitters may be sequentially activated so as to emulate a single transmitter that is effectively “moving” along the axial length of a wellbore within which the array is disposed. The receivers in an array of receivers may be activated in a similar manner. Thus, although the subterranean anomaly that is to be imaged remains stationary, the effective “movement” of the transmitter and/or receiver provides the relative movement necessary for Doppler-enhanced visualization. The signals emitted from the array of transmitters propagate through the formation, and at least some of the emitted signals are incident upon the subterranean features of interest. (For simplification, these features are often treated as a collection of point-sized anomalies, with each anomaly treatable separately.) Each receiver in the receiver array distinguishes between signals that were and that were not incident upon a given anomaly because of the signals' differing frequency signatures. The received data is subsequently processed to generate useful information (e.g., an image) regarding the subterranean anomaly. These Doppler-enhancement techniques may be implemented using both electromagnetic and acoustic/seismic equipment and, as described below, distributed acoustic sensing equipment may be particularly advantageous in acoustic/seismic applications.

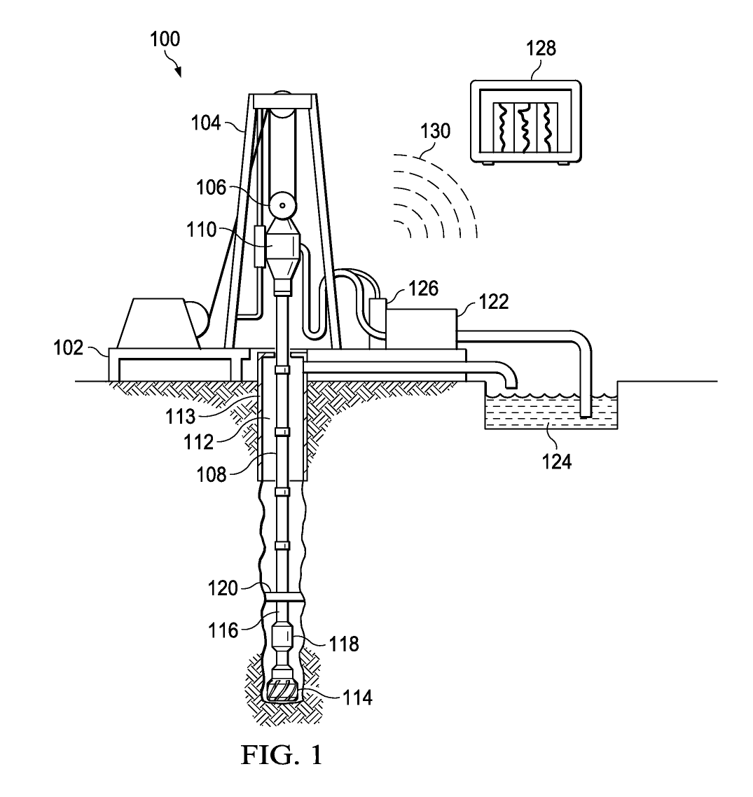

FIG. 1 is a schematic of an illustrative drilling environment 100. The drilling environment 100 comprises a drilling platform 102 that supports a derrick 104 having a traveling block 106 for raising and lowering a drill string 108. A top-drive motor 110 supports and turns the drill string 108 as it is lowered into a borehole 112. The drill string's rotation, alone or in combination with the operation of a downhole motor, drives the drill bit 114 to extend the borehole 112. The drill bit 114 is one component of a bottomhole assembly (BHA) 116 that may further include a rotary steering system (RSS) 118 and stabilizer 120 (or some other form of steering assembly) along with drill collars and logging instruments. A pump 122 circulates drilling fluid through a feed pipe to the top drive 110, downhole through the interior of drill string 108, through orifices in the drill bit 114, back to the surface via an annulus around the drill string 108, and into a retention pit 124. The drilling fluid transports formation samples—i.e., drill cuttings—from the borehole 112 into the retention pit 124 and aids in maintaining the integrity of the borehole. Formation samples may be extracted from the drilling fluid at any suitable time and location, such as from the retention pit 126. The formation samples may then be analyzed at a suitable surface-level laboratory or other facility (not specifically shown). While drilling, an upper portion of the borehole 112 may be stabilized with a casing string 113 while a lower portion of the borehole 112 remains open (uncased).

The drill collars in the BHA 116 are typically thick-walled steel pipe sections that provide weight and rigidity for the drilling process. The thick walls are also convenient sites for installing the arrays of transmitters and receivers (as described in greater detail below) and logging instruments that measure downhole conditions, various drilling parameters, and characteristics of the formations penetrated by the borehole. The BHA 116 typically further includes a navigation tool having instruments for measuring tool orientation (e.g., multi-component magnetometers and accelerometers) and a control sub with a telemetry transmitter and receiver. The control sub coordinates the operation of the various logging instruments, steering mechanisms, and drilling motors, in accordance with commands received from the surface, and provides a stream of telemetry data to the surface as needed to communicate relevant measurements and status information. A corresponding telemetry receiver and transmitter is located on or near the drilling platform 102 to complete the telemetry link. One type of telemetry link is based on modulating the flow of drilling fluid to create pressure pulses that propagate along the drill string (“mud-pulse telemetry or MPT”), but other known telemetry techniques are suitable. Much of the data obtained by the control sub may be stored in memory for later retrieval, e.g., when the BHA 116 physically returns to the surface.

A surface interface 126 serves as a hub for communicating via the telemetry link and for communicating with the various sensors and control mechanisms on the platform 102. A data processing unit (shown in FIG. 1 as a tablet computer 128) communicates with the surface interface 126 via a wired or wireless link 130, collecting and processing measurement data to generate logs and other visual representations of the acquired data and the derived models to facilitate analysis by a user. The data processing unit may take many suitable forms, including one or more of: an embedded processor, a desktop computer, a laptop computer, a central processing facility, and a virtual computer in the cloud. In each case, software on a non-transitory information storage medium may configure the processing unit to carry out the desired processing, modeling, and display generation. The data processing unit may also contain storage to store, e.g., data received from tools in the BHA 116 via mud pulse telemetry or any other suitable communication technique. The scope of disclosure is not limited to these particular examples of data processing units.

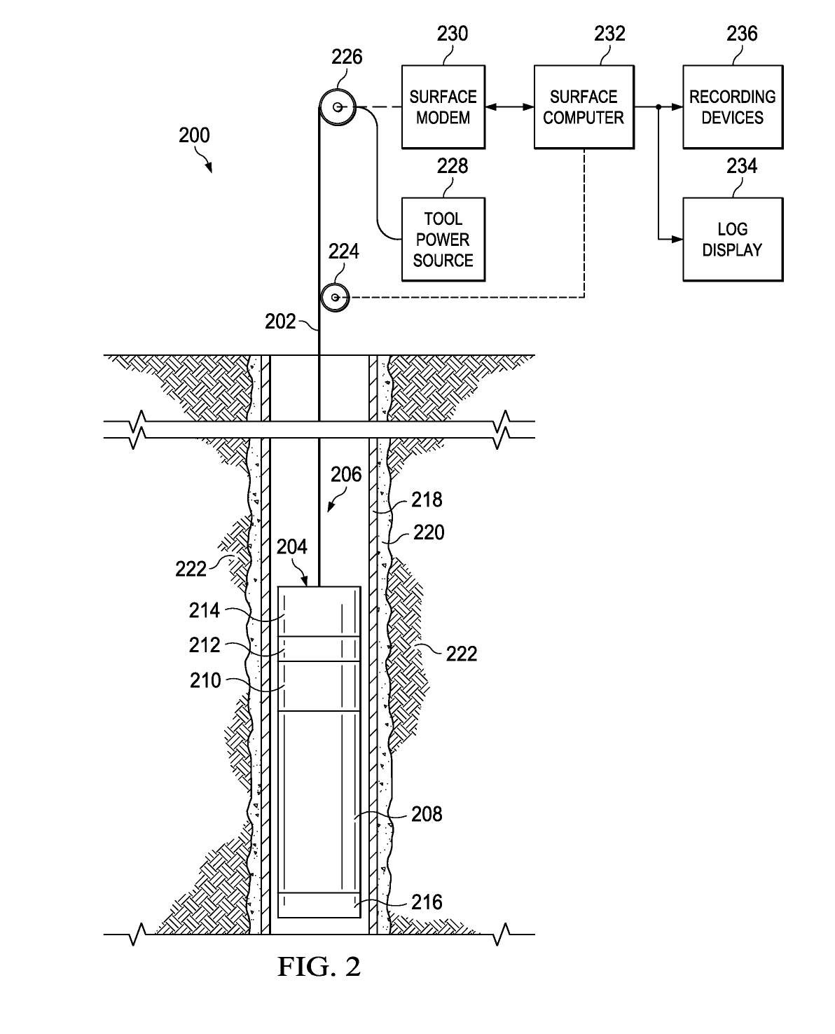

FIG. 2 is a schematic of an illustrative wireline environment 200. A logging cable 202 suspends a sonde 204 in a wellbore 206. Wellbore 206 is drilled by a drill bit on a drill string and is subsequently lined with casing 218 and an annular space 220 that contains, e.g., cement. Wellbore 206 can be any depth, and the length of logging cable 202 is sufficient for the depth of wellbore 206. Sonde 204 generally comprises a protective shell or housing that is fluid tight and pressure resistant and that enables equipment inside the sonde to be supported and protected during deployment. Sonde 204 encloses one or more logging tools that generate data useful in analyzing wellbore 206 or in determining various material properties of the formation 222 in which wellbore 206 is disposed, such as a gamma ray tool 216. The sonde 204 may also house multiple transmitters and receivers (e.g., acoustic and/or electromagnetic) and their antennas. In some embodiments employing distributed acoustic sensing (DAS) fibers, the fibers may be coiled around the sonde body. In some embodiments employing DAS fibers, the fibers may be housed within the sonde. Sonde 204 may also enclose a power supply 210. Output data streams from logging tools may be provided to a multiplexer 212 housed within sonde 204. Sonde 204 may include a communication module 214 having an uplink communication device, a downlink communication device, a data transmitter, and a data receiver.

Logging system 200 includes a sheave 224 that is used to guide the logging cable 202 into wellbore 206. Cable 202 is spooled on a cable reel 226 or drum for storage. Cable 202 couples with sonde 204 and is spooled out or taken in to raise and lower sonde 204 in wellbore 206. Conductors in cable 202 connect with surface-located equipment, which may include a DC power source 228 to provide power to tool power supply 210, a surface communication module 230 having an uplink communication device, a downlink communication device, a data transmitter and also a data receiver, a surface computer 232 (or, more generally, any suitable type of processing logic), a logging display 234 and one or more recording devices 236. Sheave 224 may be coupled by a suitable means to an input to surface computer 232 to provide sonde depth measuring information. The surface computer 232 comprises processing logic (e.g., one or more processors) and has access to software (e.g., stored on any suitable computer-readable medium housed within or coupled to the computer 232) and/or input interfaces that enable the computer 232 to perform, assisted or unassisted, one or more of the methods and techniques described herein. The computer 232 may provide an output for the logging display 234 and the recording device 236. The surface logging system 200 may collect data as a function of depth. Recording device 236 is incorporated to make a record of the collected data as a function of depth in wellbore 206.

In some embodiments, processing logic (e.g., one or more processors) and storage (e.g., any suitable computer-readable medium) may be disposed downhole within the sonde 204 and may be used either in lieu of the surface computer 232 or in addition to the computer 232. In such embodiments, storage housed within the sonde 204 stores data (such as that obtained from the logging operations described herein), which may be downloaded and processed using the surface computer 232 or other suitable processing logic once the sonde 204 has been raised to the surface (e.g., in “slickline” applications). In some embodiments, processing logic housed within the sonde 204 may process at least some of the data stored on the storage within the sonde 204 before the sonde 204 is raised to the surface.

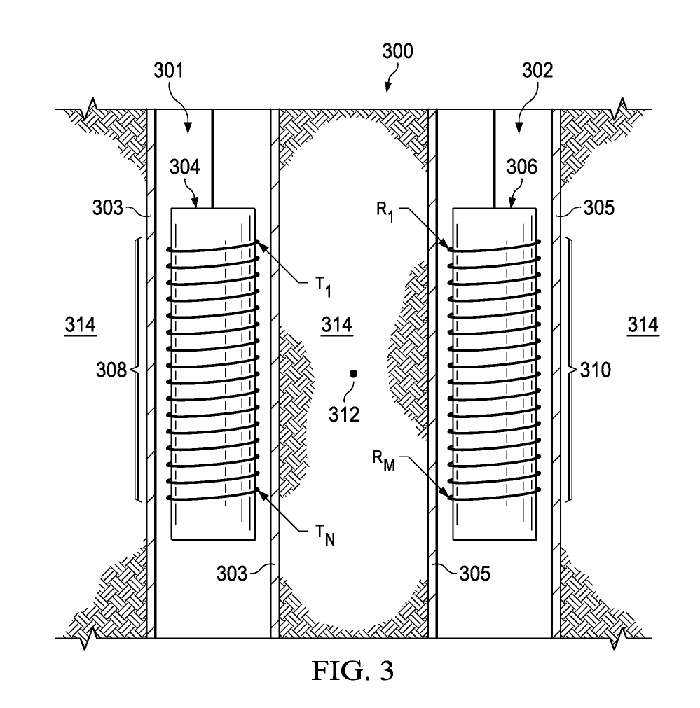

FIG. 3 is a schematic diagram showing relative positions (not to scale) for certain elements of an illustrative vertical cross-well wireline environment 300. The environment 300 comprises completed and cased wells 301, 302 disposed within a formation 314. A sonde 304 is positioned within the well 301 and a sonde 306 is positioned within the well 302. The sonde 304 comprises an array of transmitters 308 (labeled as T₁ . . . T_{N}) and sonde 306 comprises an array of receivers 310 (labeled as R₁ . . . R_{M}). In some embodiments, the transmitters and receivers in arrays 308, 310 are electromagnetic transducers (e.g., coil antennas) that emit electromagnetic waves, while in other embodiments, they are acoustic transducers (e.g., piezoelectric surfaces) that emit acoustic waves. The illustrated environment 300 also has a subterranean point anomaly 312 (e.g., a small interface or other feature in a region of interest having oil or gas deposits, water, or rock having material properties that are substantially different from those of the surrounding formation) disposed between the wells 301, 302. The various figures show point anomalies for simplicity—linearity enables the features in the region of interest to be treated as a collection of many such point anomalies. Thus, the techniques described herein may be used to image subterranean bodies of any shape or size.

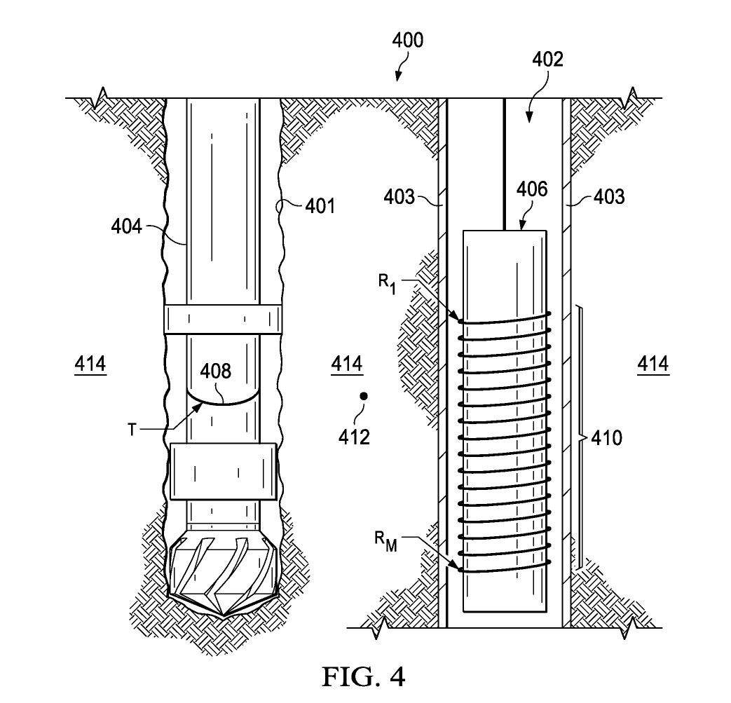

FIG. 3 is described as a schematic diagram because the transmitter array 308 and receiver array 310 are not illustrated precisely as they would appear in an actual, physical implementation of the environment 300. Instead, the arrays 308, 310 are illustrated as shown to facilitate an efficient understanding of the basic arrangement of measurement units (e.g., a single transmitter, a single receiver, an array of transmitters, an array of receivers) in the sondes 304, 306. FIGS. 4-9 also are schematic diagrams for demonstrating relative positions of the elements and should not be taken as scaled, realistic representations of the disclosed sensor configurations.

In some embodiments, the transmitters and receivers in one or both of the arrays 308, 310 are housed within wireline sondes 304, 306. In some embodiments, the transmitters and receivers in one or both of arrays 308, 310 are disposed on outer surfaces of the sondes 304, 306, possibly using insulating layers (not specifically shown) disposed between the transducers and the sonde bodies to mitigate conduction of current through the sonde bodies. In some embodiments, one or both of the arrays 308, 310 may be permanently disposed within or outside the wellbore casing strings 303, 305, respectively. For example, the arrays may be permanently deployed within the cement sheath located outside of the casing strings. Alternatively, as suggested in FIG. 4, one or both of the arrays 308, 310 may instead be deployed within drill strings—for instance, in logging-while-drilling (“LWD”) applications. In some embodiments, the arrays 308, 310 may be disposed within the same wellbore and on or within the same casing string, wireline sonde and/or drill string. Further, in some embodiments, one or both of the arrays 308, 310 may be disposed on or adjacent to the Earth's surface—for instance, on the ground, a platform, a boat, a motor vehicle or the ocean floor. Any and all such variations and combinations are contemplated and encompassed within the scope of this disclosure. Some of these different configurations are described below with respect to FIGS. 4-9.

Still referring to FIG. 3, the receivers and transmitters in the arrays 308, 310 may be of any suitable type. For instance and without limitation, electromagnetic antennas may be used in magnetic dipole (e.g., coil antenna) or electrical dipole (e.g., wire, toroid or button electrodes) form. Any combination of electrodes or antennas may be used for the transmitters and receivers in the arrays 308, 310.

Other types of transducers, such as acoustic monopole, acoustic dipole, and acoustic quadrupole antennas also may be used where suitable. In acoustic and/or seismic applications, optical fiber may be employed to act as distributed acoustic sensing (“DAS”) receivers in a variety of ways known to those of ordinary skill in the art.

In operation, the transmitters and receivers in arrays 308, 310 are activated in one or more patterns such that the system is able to collect Doppler-enhanced data, i.e., data that incorporates relative motion between the region of interest and the source and/or receiver. Such relative motion introduces an additional degree of transmit/receiver spatial diversity into the data set. Obtaining data with spatially diverse locations provides a measure of redundancy to better ensure that adequate data is available to characterize and visualize the anomaly or anomalies.

Thus, for instance, in the environment 300, a transmitter T₁ in the array 308 may be activated first, meaning that the transmitter T₁ emits a signal (e.g., an electromagnetic wave). As with any transmitter, the emitted signal propagates in multiple directions into the formation 314. At least some of the signal propagates directly to the receivers in array 310, while at least some of the signal propagates to the receivers in array 310 only after reflecting off of the anomaly 312. While transmitter T₁ is transmitting a signal, the receivers R₁-R_{M} in array 310 may be activated, either all at once, in sequential order from R₁ to R_{M}, in sequential order from R_{M} to R₁, or in any other suitable fashion. Thus, if the array 310 were to be activated in a sequential fashion from R₁ to R_{M}, the receiver R₁ would first receive the direct and indirect signals from the transmitter T₁—that is, signals from T₁ that are incident upon the anomaly 312 and reflected toward R₁. The lengths of time for which transmitter T₁ and/or any of the receivers in the array 310 are activated may be selected as desired, dependent upon the spacing between array transducers and the desired degree of Doppler enhancement. The process is then repeated with transmitter T₂ transmitting a signal and receivers R₁-R_{M} concurrently or sequentially receiving direct and indirect signals from T₂. The process is again repeated for the remaining transmitters in the transmitter array 308. The received signals are then provided to processing logic (e.g., within the sondes, at the surface, or both) to be processed as described further below.

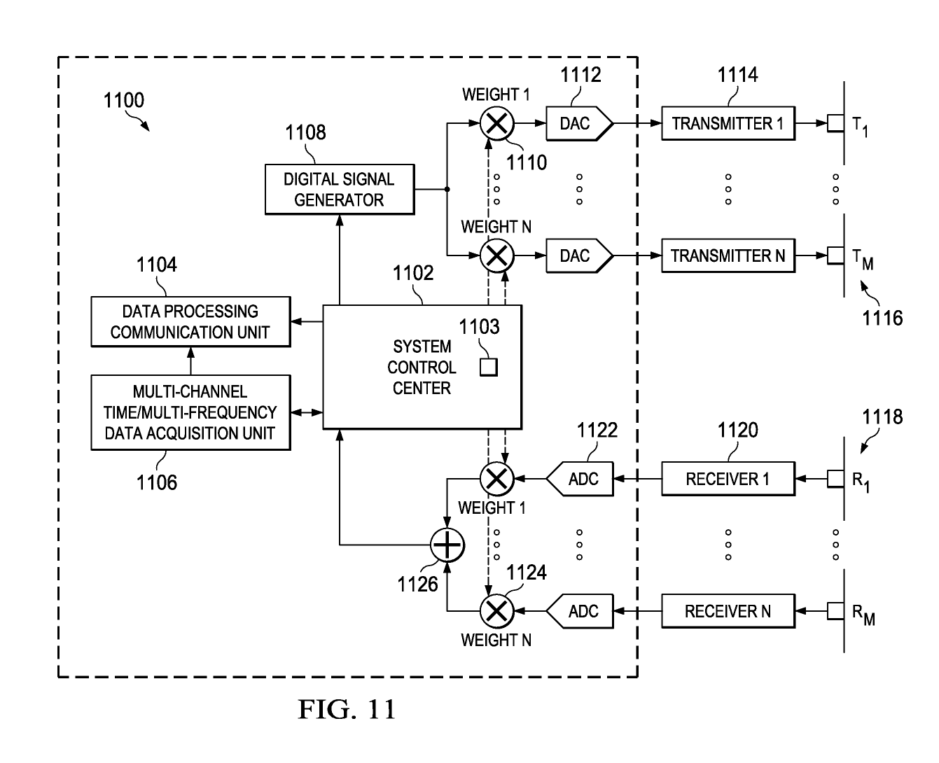

The term “activation”—as it is used herein to describe the operation of transmitters and receivers—is broad. It may mean that the transmitter or receiver in question is powered on while its default state is to be powered off. For instance, an “activated” transmitter T₁ means that although T₁ defaults to being powered off, it is temporarily powered on for the purpose of transmitting a signal. Alternatively, the term may mean that the transmitter or receiver in question is always powered on, but that its signal—whether being transmitted or received—is assigned a greater weight than signals being handled by the other transmitters or receivers in the same array. Thus, for example, an “activated” transmitter T₁ may be powered on in its default state but the signal it is transmitting may be assigned a greater weight than the signals that transmitters T₂-T_{N} are transmitting or are attempting to transmit. This weighting technique is described in additional detail with respect to FIG. 11 below. In preferred embodiments, no more than two consecutive transmitters or receivers in a single array are active at the same time, although the scope of disclosure is not limited as such.

In any case, by activating the transmitters in the array 308 in a sequential manner, the array 308 may be characterized as a single source that effectively “moves” along the length of the array. The accuracy of this characterization is maximized where the transducer spacing is some fraction of a wavelength—for instance, if the transducer spacing is half of a wavelength. In another example, in rock where the speed of sound averages 7000 m/s, acoustic transmitters or receivers operating at a characteristic frequency of 10 kHz might have an array spacing of 0.35 m (one half wavelength). Electromagnetic signals propagate around 3×10⁸ m/s, so with a 3 MHz signal, a suitable array spacing might be 10 m (one tenth wavelength).

The receivers in the array 310 can be similarly activated in a sequential manner, enabling the array 310 to be characterized as a single receiver that effectively “moves” along the axis of the sonde 306. As with the transmitters, this technique is substantially faster than physically moving a single receiver along the axis of the wellbore 302. In addition, the scope of disclosure is not limited to implementing effective movement in linear transmitter and receiver arrays. Any suitable piecewise, continuous shape (e.g., arcs, L-shapes) may be used.

As explained above, numerous variations, combinations and arrangements of measurement units (e.g., individuals transmitters and receivers; arrays of transmitters and receivers) are possible and fall within the scope of this disclosure. The embodiments now described with respect to FIGS. 4-9 represent some of these possible arrangements. These figures and their accompanying descriptions do not limit the scope of disclosure. The various features and arrangements described may be mixed or modified as may be suitable. In addition, various facets of the description of FIG. 3 provided above (for example and without limitation, the types of transmitter and receiver antennas that may be used; the manner in which the transmitters and receivers may be deployed on or within sondes, drill strings, within or around casing, in cement sheaths, or on or near the Earth's surface; and specific terminology, including “activated,” “effective movement” and “measurement units”) generally applies to FIGS. 4-9 and the corresponding descriptions as well.

FIG. 4 is a schematic of an illustrative vertical cross-well drilling and wireline environment 400. The environment 400 comprises a borehole 401 and a completed well 402 (lined with casing string 403) disposed within a formation 414. A drill string 404 is positioned within the borehole 401 and a wireline sonde 406 is disposed within the well 402. A transmitter 408 (also denoted with a “T”) is disposed on or within a bottomhole assembly (“BHA”) of the drill string 404. An array of receivers 410 (including receivers R₁-R_{M}) is positioned on or within the sonde 406. An anomaly 412 is situated in the formation 414 between the borehole 401 and the well 402.

In operation, the transmitter 408 moves vertically along the axial length of the borehole 401 as the drill string 404 drills deeper into the formation 414. The transmitter 408 is kept in an active state during this movement, transmitting signals (e.g., electromagnetic waves) into the formation 414. Receivers R₁-R_{M} in the array 410 may be activated in sequence from R₁ to R_{M} or R_{M} to R₁. Alternatively, they may all be activated at the same time. In either case, the receivers in the array 410 receive signals that propagate from the transmitter 408 and through the formation. Some of these signals are incident upon the anomaly 412 and some are not. Processing logic that interprets the received signals is able to distinguish between signals that are and that are not incident upon the anomaly 412 based on the signals' frequency signatures.

Just as each of the receivers in the array 310 in FIG. 3 was activated each time a different transmitter in the array 308 was activated, in environment 400, each of the receivers in the array 410 is activated periodically such that they receive signals that have been transmitted by transmitter 408 from various different depths within the borehole 401. For instance, drilling may be momentarily halted at a depth of 1000 feet and the transmitter 408 may transmit signals at that depth. Each of the receivers in the array 410 may be activated sequentially to collect these signals. Drilling may be resumed and then again paused at a depth of 1100 feet. The transmitter 408 may transmit signals at this new depth, and each of the receivers in the array 410 may collect these signals, which are different from the signals transmitted at 1000 feet. Such transmission-reception intervals may be set based on depth, time or both. Although FIG. 4 includes a single transmitter 408, movement of the transmitter is not absolutely required, given that the receivers in the receiver array 410 effectively move and thus provide the relative movement necessary to use the Doppler effect.

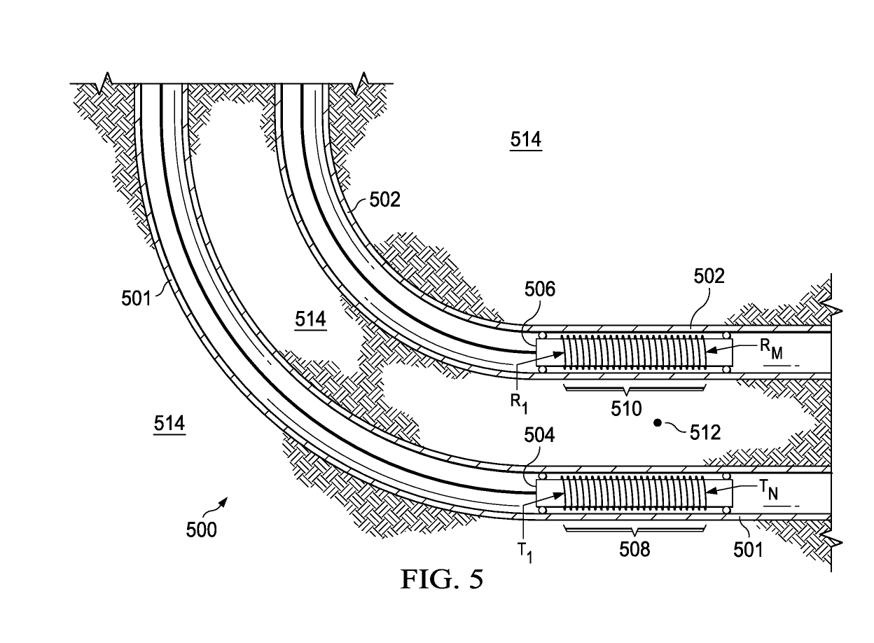

FIG. 5 is a schematic of an illustrative horizontal cross-well wireline environment 500. The environment 500 comprises horizontal wells 501, 502 disposed within formation 514. Wireline sondes 504, 506 are positioned within wells 501, 502, respectively, using wireline tractors. An array 508 of transmitters T₁-T_{N} is positioned on or within the sonde 504, and an array 510 of receivers R₁-R_{N} is positioned on or within the sonde 506. In some embodiments, and as with any of the embodiments shown in FIGS. 3-9, the transmitters and receivers may trade places such that the transmitters are within the well 502 and the receivers are within well 501. The environment 500 includes an anomaly 512 between the wells 501, 502. The arrays 508, 510 operate in a manner that is similar to the operation of the arrays in FIGS. 3 and 4.

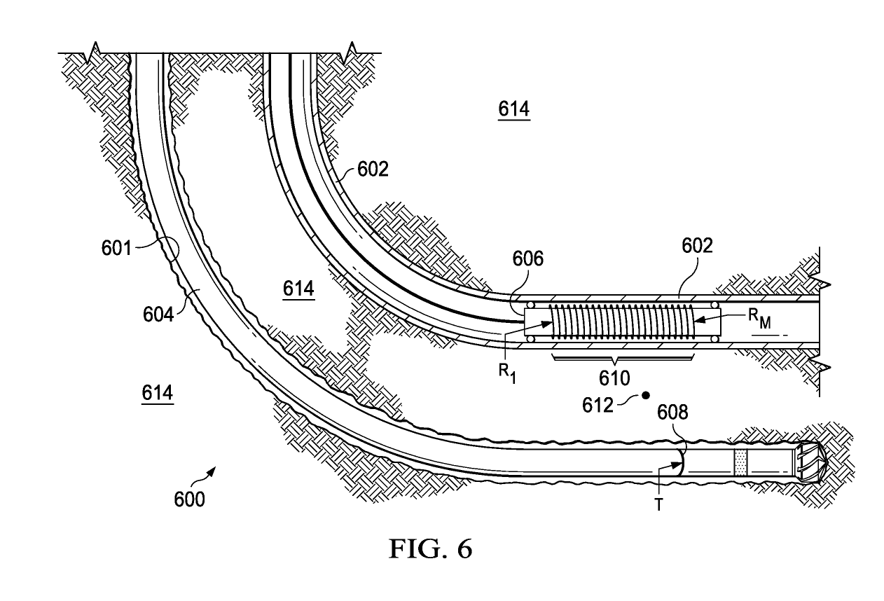

FIG. 6 is a schematic of an illustrative horizontal cross-well drilling and wireline environment 600. The environment 600 comprises a horizontal borehole 601 and completed horizontal well 602, both of which are disposed within formation 614. The borehole 601 is being drilled using drill string 604, which contains or has on its surface a transmitter 608. A wireline sonde 606 is disposed within the well 602, possibly using a wireline tractor. An array 610 of receivers R₁-R_{M} is positioned on or within the sonde 606. The transmitter and receivers in environment 600 operate in a manner that is similar to the operation of the transmitters and receivers in FIGS. 3-5.

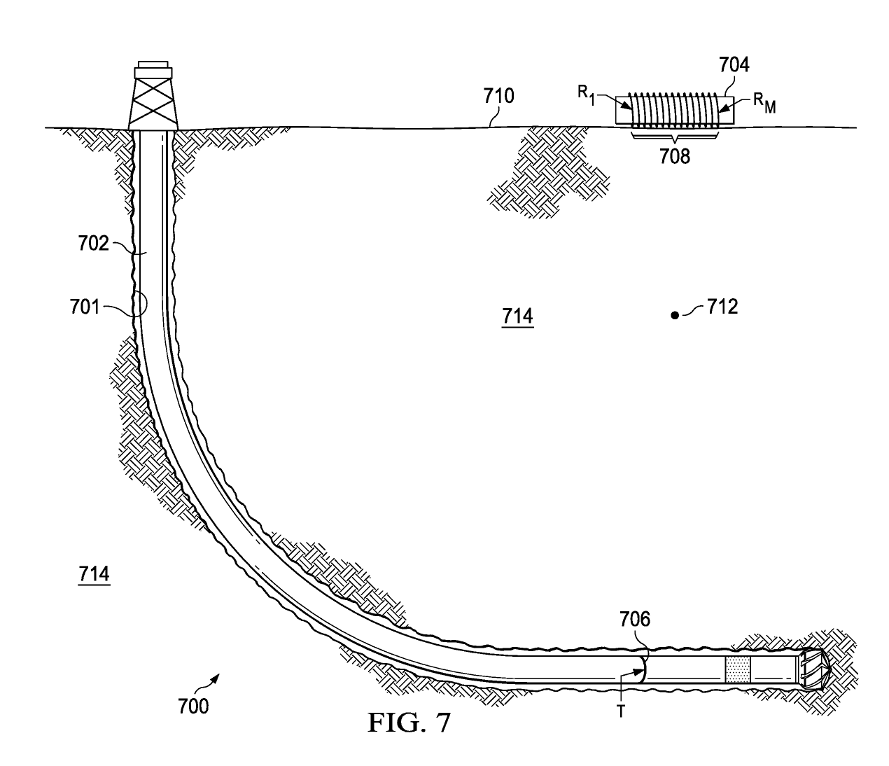

FIG. 7 is a schematic of an illustrative well-to-surface environment 700. The environment 700 comprises a borehole 701 disposed within a formation 714. A drill string drills within the borehole 701 and has positioned upon or within it a transmitter 706. An array 708 of receivers R₁-R_{M} is positioned on or near the Earth's surface 710. The array 708 may be disposed on any suitable object 704 (e.g., a non-conductive cylinder). In some embodiments, the array 708 is positioned on an ocean floor or is mobile and is thus positioned on a boat or a motor vehicle. An anomaly 712 is positioned between the borehole 701 and the array 708, as shown. The transmitter and receivers in environment 700 operate in a manner that is similar to the operation of the transmitters and receivers in FIGS. 3-6.

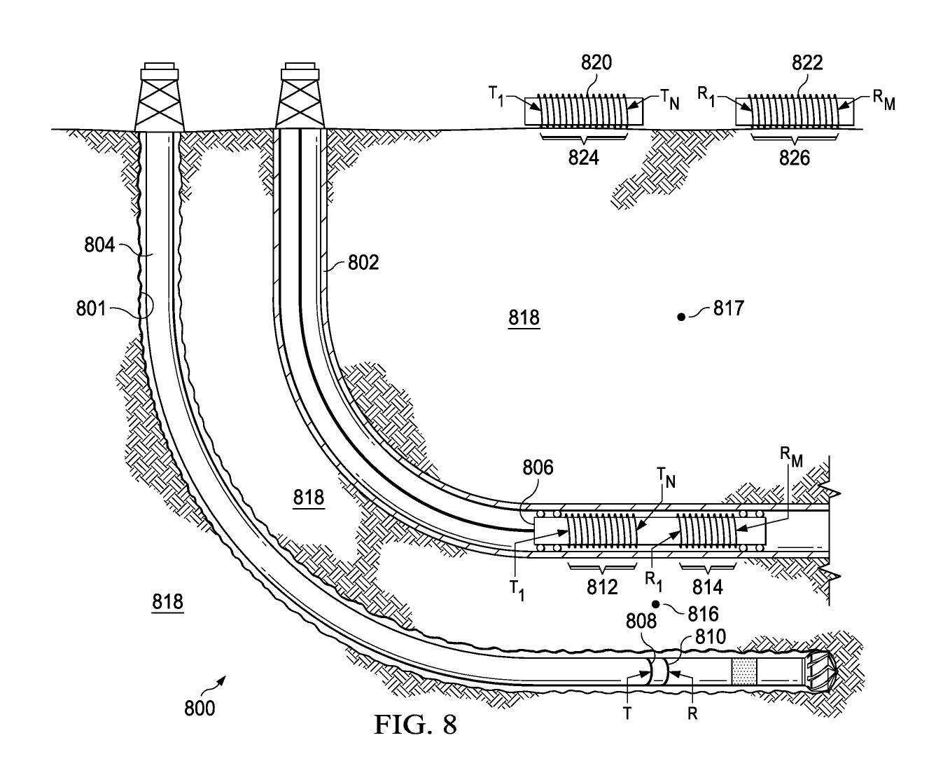

In some embodiments, three or more arrays of transmitters or receivers may be deployed to increase the spatial diversity of signals transmitted between the transmitters and receivers. Having three or more arrays of transmitters or receivers is particularly helpful in generating three-dimensional images of the anomaly or anomalies being analyzed. FIG. 8 is a schematic of an acoustic cross-well and well-to-surface environment 800. The environment 800 comprises a borehole 801 and a completed well 802 disposed within a formation 818. A drill string 804 drills within the borehole 801 and has positioned on or within it a transmitter 808 and a receiver 810. The completed well 802 contains a wireline sonde 806 having an array 812 of transmitters T₁-T_{N} and an array 814 of receivers R₁-R_{M}. In addition, the environment 800 comprises an array 824 of transmitters T₁-T_{N} positioned on or within a non-conductive body 820 and an array 826 of receivers R₁-R_{M} positioned on or within a non-conductive body 822 at or near the Earth's surface 828. The formation 818 comprises anomalies 816, 817, positioned as shown.

Any of the receivers deployed in the environment 800 may receive signals transmitted by any of the transmitters in the environment 800. For instance, in some embodiments the transmitter 808 transmits signals that propagate into the formation 818. At least some of these signals—whether incident upon the anomaly 816 or not—are received by the receiver 810. These signals may be processed to acquire information about the anomaly 816 as described below. In some embodiments, multiple receivers in spatially disparate locations may receive the signals so as to enhance the resolution and accuracy of the generated image. For instance, signals transmitted by the transmitter 808 may be received by receiver 810, any of the receivers in array 814, any of the receivers in array 826, or some combination thereof. Similarly, signals may be transmitted from multiple transmitters and received by a single receiver or by multiple receivers. For instance, transmitters in the array 812 may transmit signals that propagate into the formation 818 in the direction of the anomaly 816 as well as the anomaly 817. Receivers in the array 826 may receive signals (both incident upon the anomaly 817 and not incident upon the anomaly 817) generated by the transmitters in array 812. Receiver 810 may receive signals incident upon the anomaly 816 and signals received directly from the transmitter array 812. Transmitter array 820 also may be used to transmit signals (e.g., using a different frequency signature to avoid confusion with signals transmitted by one or more other transmitters) that may be received by, e.g., receiver arrays 814 and 826. Any and all such variations and combinations are contemplated. The movements of the drill string 804 and sonde 806 may be coordinated to obtain desired transmission-reception time and/or spatial intervals.

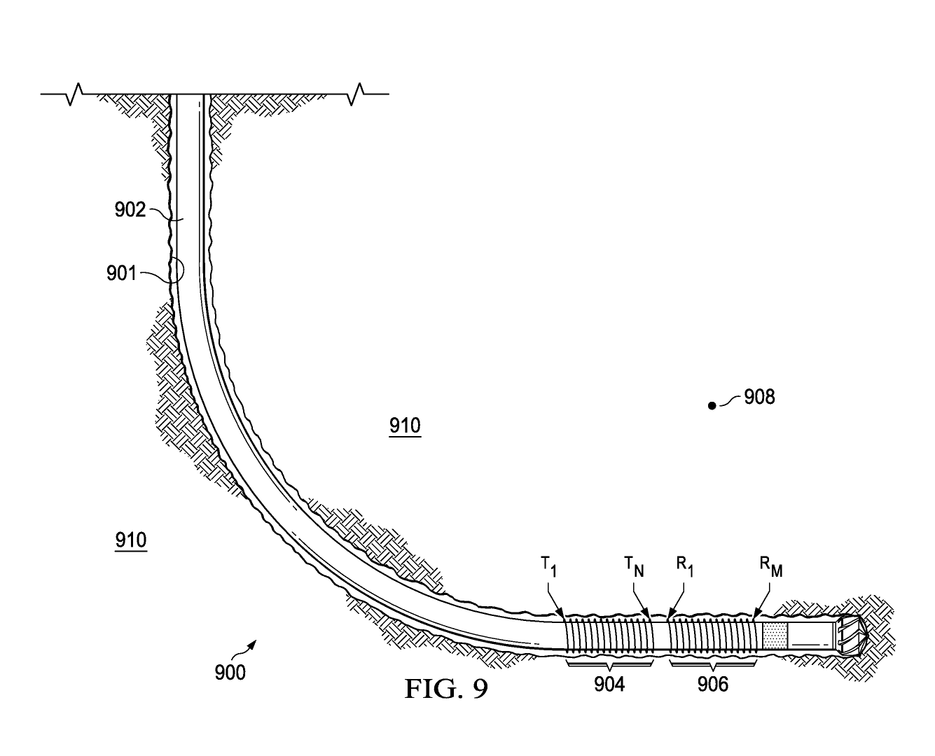

FIG. 9 is a schematic of an acoustic single-well environment 900. The environment 900 comprises a borehole 901 drilled within a formation 910. A drill string 902 is disposed within the borehole 901 and has an array 904 of transmitters T₁-T_{N} and an array 906 of receivers R₁-R_{M} positioned on or within the drill string 902. The formation 910 has an anomaly 908. In operation, the transmitter array 904 transmits signals, at least some of which are incident upon the anomaly 908. As with the other embodiments described herein, the receiver array 906 receives signals, at least some of which were incident upon the anomaly 908 and some of which were not. The received signals that were incident upon the anomaly 908 can be distinguished from the ones that were not incident upon the anomaly 908 by their differing frequency signatures. The signals are processed to acquire information about the anomaly 908, as described below.

In any suitable embodiment, including—but not limited to—the embodiments disclosed above with respect to FIGS. 3-9, any of a variety of antennas may be used to facilitate transmission and reception of signals. In some embodiments, transmitters transmit electromagnetic signals. In such embodiments, dipole antennas may be used, including coils, wires, toroids and buttons. Furthermore, the transmitter and/or receiver arrays may be of any suitable, piecewise, continuous shape, including—but not limited to—linear, arcs and L-shapes. In some embodiments, transmitters transmit sound waves (i.e., acoustic signals) into the surrounding formation. The sound waves propagate through the formation and reflections occur in case of acoustic impedance changes within the formation (e.g., at a subterranean anomaly). In some of these embodiments, very low frequency sound waves are used for seismic applications (e.g., on the order of 1 to 10 Hertz) because such low frequency signals have low attenuation in subterranean applications and thus are useful for reservoir-scale imaging. In these acoustic/seismic embodiments, the antennas used for transmitters and receivers may include any device that converts energy between electric and kinetic forms. Non-limiting examples of transmitters used in such acoustic/seismic applications include piezoelectric, shaker, moving coil or impact type devices (e.g., seismic hammers). Non-limiting examples of receivers used in such acoustic/seismic applications include hydrophones, piezoelectric, moving coil or fiber-distributed acoustic sensing (“DAS”) devices. Both transmitters and receivers in acoustic/seismic embodiments may be placed in monopole, dipole or quadrupole configurations.

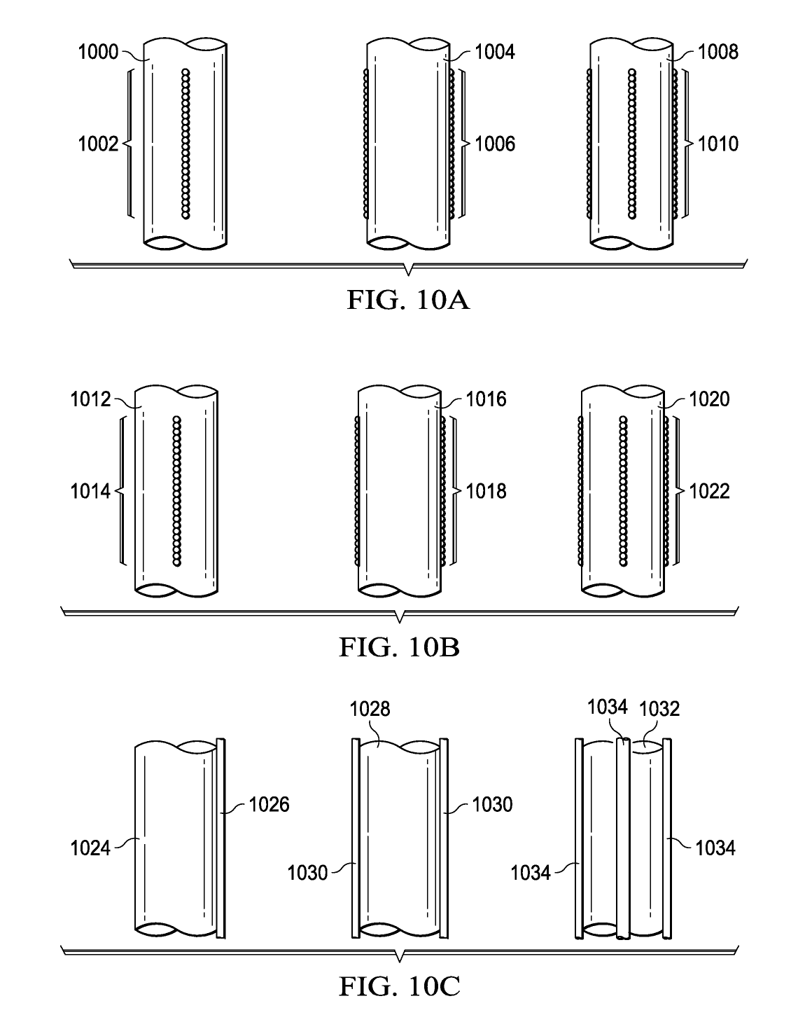

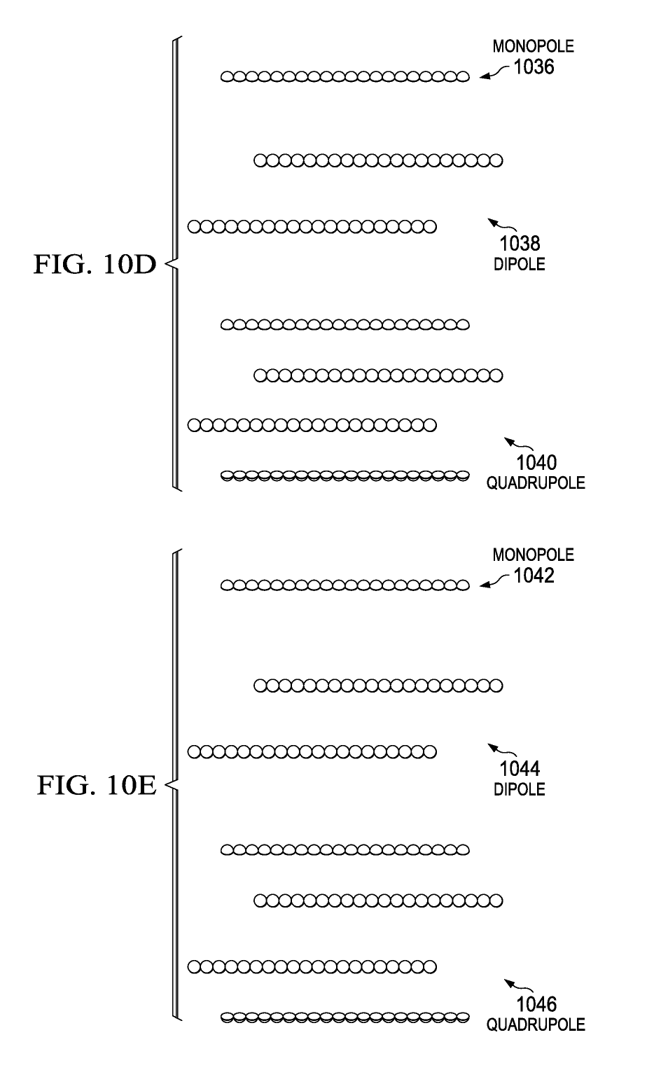

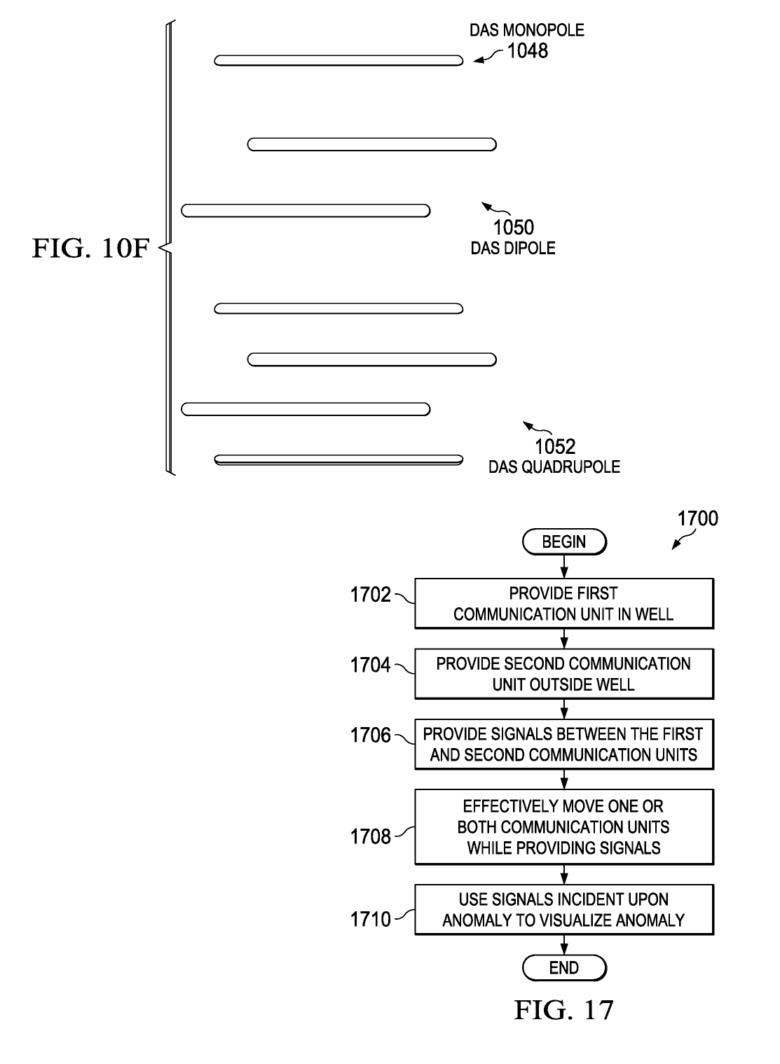

FIGS. 10A-10F are schematics of transmitters and receivers usable to implement the Doppler techniques described herein in acoustic/seismic embodiments. FIG. 10A shows illustrative monopole, dipole and quadrupole configurations that may be used in downhole transmitter arrays. Specifically, antennas 1002 are implemented in a monopole configuration on body 1000 (e.g., drill strings and/or wireline sondes); antennas 1006 (e.g., spaced 180 degrees apart) are implemented in a dipole configuration on body 1004; and antennas 1010 (e.g., spaced 90 degrees apart) are implemented in a quadrupole configuration on body 1008. FIG. 10B shows illustrative monopole, dipole and quadrupole configurations that may be used in downhole receiver arrays. In particular, antennas 1014 are disposed in a monopole configuration on body 1012; antennas 1018 are disposed in a dipole configuration on body 1016; and antennas 1022 are disposed in a quadrupole configuration on body 1020. FIG. 10C shows illustrative DAS monopole, dipole and quadrupole configurations that may be used in downhole DAS receivers. In particular, a DAS fiber 1026 is disposed on body 1024 in a monopole configuration; DAS fibers 1030 are disposed on body 1028 in a dipole configuration; and DAS fibers 1034 are disposed on body 1032 in a quadrupole configuration. FIG. 10D shows illustrative monopole, dipole and quadrupole configurations that may be used in surface transmitter arrays. Specifically, antennas 1036 are arranged in a monopole configuration; antennas 1038 are arranged in a dipole configuration; and antennas 1040 are arranged in a quadrupole configuration. FIG. 10E shows illustrative monopole, dipole and quadrupole configurations that may be used in surface receiver arrays. In particular, antennas 1042 are arranged in a monopole configuration; antennas 1044 are arranged in a dipole configuration; and antennas 1046 are arranged in a quadrupole configuration. Finally, FIG. 10F shows illustrative DAS monopole, dipole and quadrupole surface receiver array configurations. In particular, DAS fiber 1048 is in a monopole configuration; DAS fibers 1050 are arranged in a dipole configuration; and DAS fibers 1052 are arranged in a quadrupole configuration.

Embodiments using DAS employ fiber optic cables to provide distributed acoustic frequency strain sensing over potentially large distances. A DAS controller (e.g., processing logic) provides laser light pulses within the fiber optic cable. The DAS controller and fiber use a phenomenon known as Rayleigh scattering to detect acoustic/seismic signals that disturb the DAS fiber, thereby causing the laser light to scatter within the fiber. The spatial resolution of a DAS fiber—that is, the spacing of points along the fiber where acoustic/seismic signals may be detected—is largely determined by the duration of the laser pulse transmitted down the DAS fiber. In some embodiments, the spatial resolution is 10 meters. Higher resolutions may be obtained by using shorter, more powerful laser pulses. Because of its function as a continuous receiver using laser-based fiber optics, DAS receivers have long ranges (e.g., 40-50 kilometers) and they may cover the entire length of a well without the need for repeaters to boost signal strength. DAS fibers are particularly valuable because they can be used to implement a relatively large number of independent reception positions (e.g., 1000 or more along a single fiber) in the embodiments described herein. The embodiments described herein generally assume that a receiver array has numerous receivers that are sequentially activated. A DAS fiber may be substituted for such receiver arrays in some or all of the embodiments described or contemplated herein. In embodiments where such substitutions are made, it is generally unnecessary to activate reception positions along the fiber in a consecutive fashion as with the receiver arrays. On the contrary, all parts of the DAS fiber are capable of sensing a received acoustic/seismic signal at any time, subject to the spatial resolution for that particular DAS fiber, which may be increased or decreased as described above. Thus, the DAS fiber may be used to detect incoming acoustic/seismic signals at multiple locations along the fiber, thereby collecting data with the same degree of spatial diversity as is collected with sequentially activated receiver arrays. Processing the data collected in this manner provides the spatial diversity necessary to leverage the Doppler effect to acquire information about the target anomaly.

FIG. 11 is a schematic of illustrative processing logic 1100. The processing logic 1100 comprises a system control center 1102, a data processing communication unit 1104, a multi-channel time/multi-frequency data acquisition unit 1106, a digital signal generator 1108, one or more weighting units 1110, and one or more digital-to-analog converters 1112. In addition, the processing logic 1110 comprises one or more analog-to-digital converters 1122, one or more weighting units 1124, and a signal combination unit 1126. The scope of disclosure is not limited to the specific components and arrangement shown in FIG. 11. The digital-to-analog converter(s) 1112 couples to one or more transmitters 1114 which, in turn, couple to one or more transmitting antennas 1116. Similarly, the analog-to-digital converter(s) 1122 couples to one or more receivers 1120 which, in turn, couples to one or more receiving antennas 1118. The transmitting antennas 1116 and receiving antennas 1118 may be any of the types of antennas described above, although the scope of disclosure is not limited to those types of antennas.

In some embodiments, some or all of the processing logic 1100 may be housed within a computer (e.g., the computer 128 of FIG. 1; the surface computer 232 of FIG. 2), and other portions of the processing logic 1100, if any, may be communicatively coupled to the computer. Similarly, in some embodiments, some or all of the processing logic 1100 may be housed within a wireline sonde, within a drill string, and/or within a casing string. In embodiments where the portions of the processing logic 1100 are not co-located, the different components of the logic 1100 may communicate using any suitable technology (e.g., telemetry, wireless networks). The specific embodiments represented by FIG. 11 are merely representative and do not limit the scope of disclosure. To the contrary, the configuration shown in FIG. 11 may be modified as may be suitable to achieve the desired, synchronized activation of transmitters and receivers.

In operation, the system control center 1102 executes software code 1103 to perform some or all of its actions. The system control center 1102 determines the manner in which it will activate the transmitters 1114. For instance and without limitation, the center 1102 determines the precise characteristics (e.g., amplitude, phase) of signals to be transmitted and the timing of such transmissions by each transmitter 1114. The center 1102 and software 1103 determine this information based on any of a variety of factors that will be apparent to one of ordinary skill in the art, including—but not limited to—the material properties of the formation at the depths of operation; desired resolution of the anomaly image; optimal spatial diversity for transmissions and receptions as determined by appropriate personnel; timing of receiver activation, etc. The center 1102 provides this information to the digital signal generator 1108, which generates the signals to be transmitted.

The center 1102 also activates weighting units 1110 in accordance with the transmitter activation scheme that it will use. The weighting units 1110 apply weights to the digital signals received from the generator 1108. The amount of weight applied by a weighting unit determines the strength at which the corresponding signal is transmitted. Thus, for instance, if at a given point in time the signal being transmitted by transmitter 1 is to be dominant over the signals transmitted by the remaining transmitters, 100% of the weight will be applied by weighting unit 1 and 0% will be applied by the remaining weighting units. In some embodiments, a weighting scheme is used such that no more than two consecutively-positioned antennas radiate at the same time. In some embodiments, weights may be increased and decreased in a gradual manner so that the sequential activation of transmitters in an array is in a “smooth” motion. For instance, as the weight being applied to transmitter 1 is gradually decreased, the weight being applied to transmitter 2 is gradually increased. This is in contrast to a weighting scheme wherein the weight applied to transmitter 1 is abruptly decreased from, e.g., 100% to 0% and the weight applied to transmitter 2 is abruptly increased from, e.g., 0% to 100%. After being weighted by weighting units 1110, the signals are converted to analog format by converters 1112 and are transmitted by transmitters 1114 and antennas 1116. The weights ensure that the hand-offs between transmitters and receivers are sufficiently smooth to eliminate high frequency ringing artifacts associated with abrupt transitions, to fit the signal bandwidth to an available lossy channel, and to reduce the number of physical transmitters required for the operation. Multi-channel time/multi-frequency acquisition unit 1106 converts the data to a format suitable for storing with associated time- or depth-stamps, and stores it for communication to the surface. Data processing communication unit 1104 modulates the data for communication and relays it to the surface using one of the available telemetry methods (e.g., mud-pulse, EM-pulse, etc.).

Signals received by the receivers 1120 and antennas 1118 are converted to digital signals by converters 1122 and are weighted by weighting units 1124 for combination at combination unit 1126. Signals are then provided to the system control center 1102 to acquire information about a subterranean anomaly, as described below. In some embodiments, the weighting units 1124 implement a gradual-transition weighting scheme as described above with respect to weighting units 1110.

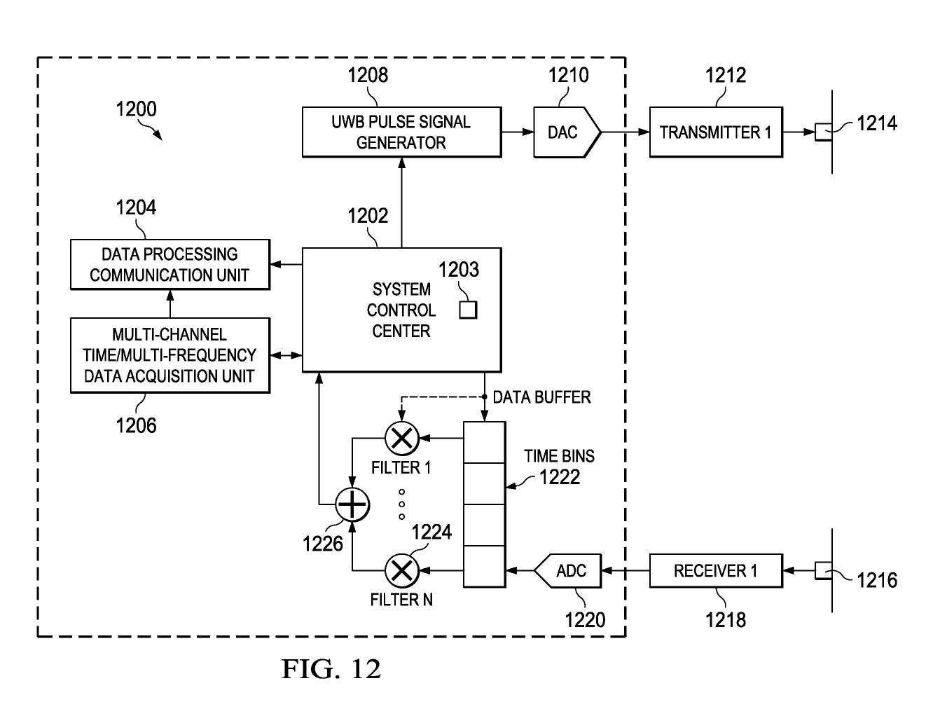

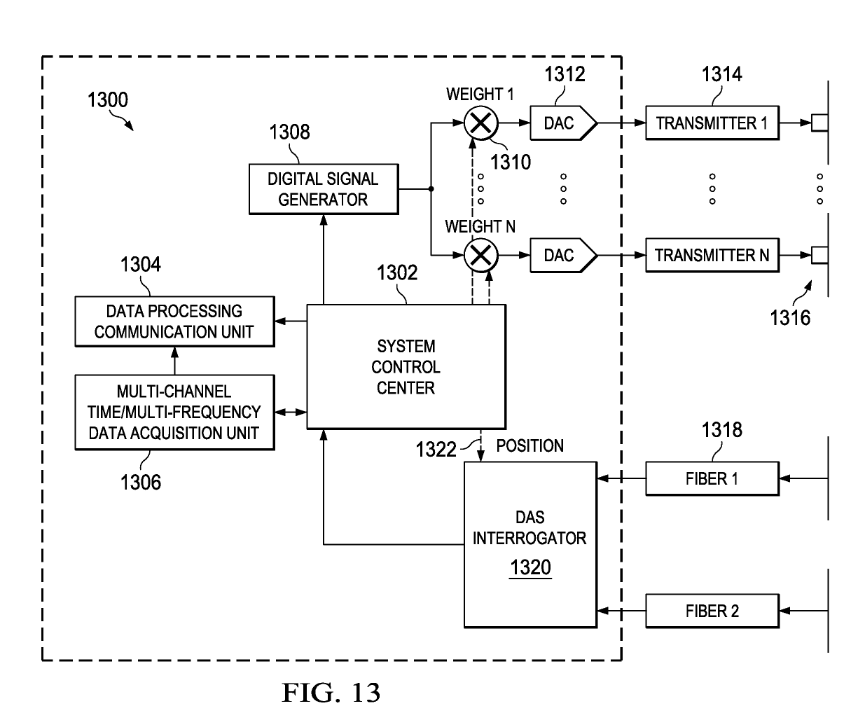

FIG. 12 is a schematic of illustrative, time-lapsed processing logic 1200. The processing logic 1200 is suitable for use in single-transmitter and/or single-receiver embodiments. The processing logic 1200 may be embodied as described above with respect to processing logic 1100. The processing logic 1200 comprises a system control center 1202 storing software 1203. The processing logic 1200 also comprises data processing communication unit 1204 and multi-channel time/multi-frequency data acquisition unit 1206. The processing logic 1200 further comprises ultra-wide band pulse signal generator 1208 and digital-to-analog converter 1210. The processing logic 1200 still further comprises an analog-to-digital converter 1220, a data buffer 1222 comprising a plurality of time bins, a plurality of filters 1224 and a combination unit 1226. The digital-to-analog converter 1210 couples to transmitter 1212 and transmitting antenna 1214, while the analog-to-digital converter 1220 couples to receiver 1218 and receiving antenna 1216.

In operation, the system control center 1202 executes the software 1203, which causes the center 1202 to perform its actions. Specifically, the center 1202 determines the signals (e.g., amplitude, phase, timing) that are to be transmitted. The center 1202 determines this information in the same or similar manner that the center 1102 of FIG. 11 determines such information. The center 1202 provides this information to the UWB pulse signal generator 1208. The signal generator 1208 generates the appropriate signals based on the information received from the center 1202 and provides the signals to the digital-to-analog converter 1210. The analog signal output by the converter 1210 is provided to the transmitter 1212 and antenna 1214 for transmission. Multi-channel time/multi-frequency acquisition unit 1206 converts the data to a format suitable for storing with associated time- or depth-stamps, and stores it for communication to the surface. Data processing communication unit 1204 modulates the data for communication and relays it to the surface using one of the available telemetry methods (e.g., mud-pulse, EM-pulse, etc.).

In embodiments deploying the processing logic 1200, the receiver 1218 and receiving antenna 1216 take multiple antenna measurements with impulse (or ultra wide band) excitation at different times as drilling occurs. The analog-to-digital converter 1220 converts the received signals to digital form, and the time signature associated with each measurement is stored in the time bins of data buffer 1222. A filtering scheme, provided by the system control center 1202 for application by the filters 1224, is then applied to the collection of received data in the buffer 1222. The timing of data acquisitions for each bin is determined by the system control center 1202, which seeks a predetermined spatial separation in between acquisitions as the drill string or wireline sonde moves through the borehole. Similar to the weights that are applied to the excitation pulses, filters smooth out the hand-offs between different receivers, eliminate high frequency ringing artifacts associated with abrupt transitions, fit the signal bandwidth to available lossy channels, and reduce the number of physical receivers required for the operation. The filtered data is then provided to the system control center 1202 for processing as described further below.

FIG. 13 is a schematic of illustrative processing logic 1300 using distributed acoustic sensing (DAS). Specifically, the processing logic 1300 is deployed in embodiments using fiber DAS receivers (e.g., acoustic/seismic applications). The processing logic 1300 may be embodied in the same manner as the processing logic 1100 and 1200 described above. The processing logic 1300 comprises a system control center 1302 storing software 1303, data processing communication unit 1304, multi-channel time/multi-frequency data acquisition unit 1306, a digital signal generator 1308, weighting units 1310, and digital-to-analog converters 1312. The processing logic 1300 further comprises a DAS interrogator 1320 and position signal 1322. The digital-to-analog converters 1312 couple to transmitters 1314 and transmitting antennas 1316. Similarly, the DAS interrogator 1320 couples to DAS fibers (i.e., receivers) 1318.

In operation, the system control center 1302 executes software 1303 to determine, e.g., the signals that are to be transmitted by the transmitters 1314. The center 1302 determines this information in the same or similar manner that the center 1102 of FIG. 11 determines this information. The center 1302 provides this information to the digital signal generator 1308, which generates the digital signals and provides them to weighting units 1310. The weighting units 1310 function in the same or similar manner that the weighting units 1110 of FIG. 11 function. The weighted signals are provided to digital-to-analog converters 1312 for conversion to analog form, at which point they are transmitted by transmitters 1314 and antennas 1316.

Multi-channel time/multi-frequency acquisition unit 1306 converts the data to a format suitable for storing with associated time- or depth-stamps, and stores it for communication to the surface. Data processing communication unit 1304 modulates the data for communication and relays it to the surface using one of the available telemetry methods (e.g., mud-pulse, EM-pulse, etc.). The DAS fibers 1318 receive signals at any appropriate reception point(s) along their lengths, which causes laser pulses within the fibers to scatter. The scattered light is provided to the DAS interrogator 1320, which interprets the light to determine characteristics of the acoustic/seismic signal that disturbed the DAS fiber and where the disturbance occurred. The information from the DAS interrogator 1320 is then provided to the system control center 1302 for processing, as described below.

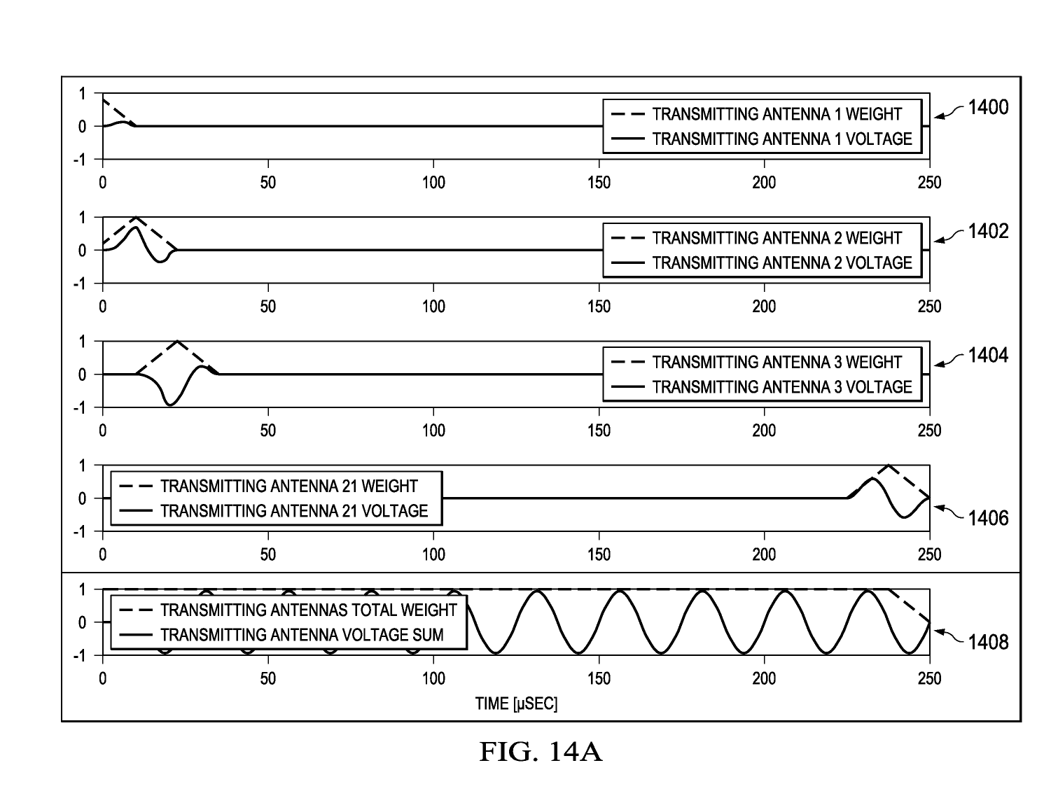

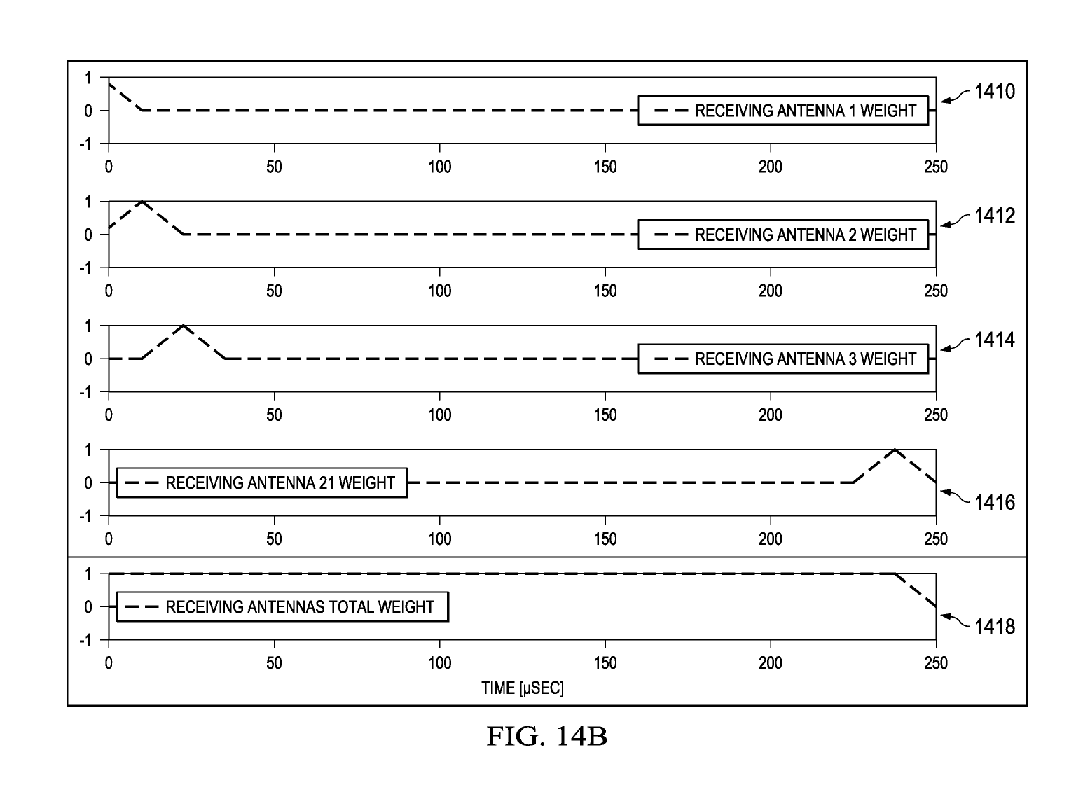

FIGS. 14A-14B are graphs of illustrative transducer array weighting signals as a function of time. Specifically, FIG. 14A shows graphs that demonstrate one manner in which weights may be applied to signals that are to be transmitted by a transmitter array in sequential order. Graph 1400 corresponds to the first antenna in the array, graph 1402 corresponds to the second antenna in the array, graph 1404 corresponds to the third antenna in the array, graph 1406 corresponds to the final antenna in the array, and graph 1408 shows the total weight applied across all antennas and the total signal output by the transmitting array. Each graph 1400-1406 shows, as a function of time, the weight applied to the signal for a corresponding transmission antenna and the transmitting antenna voltage. As graphs 1400-1406 demonstrate, the weighting scheme achieves a smooth, even “hand-off” from one antenna in the array to the next. As one transmission antenna gradually decreases its signal strength, the next antenna in the array gradually increases its signal strength. Graph 1408 shows the end result of the weighting scheme, which is a sinusoidal voltage curve. In addition, graph 1408 shows that the sum of all weights applied across all transmitting antennas is 1.0.

In FIG. 14B, graphs 1410, 1412, 1414 and 1416 show weights applied to the first, second, third and final antennas in a receiving antenna array. As with the transmitting array, weights are applied in a gradual, even manner here such that reception strength for one receiver in the array is gradually decreased as the strength for the next receiver in the array is gradually increased. Graph 1418 demonstrates that the sum of all weights applied across all receiving antennas is 1.0.

The various relationships for the signals, transmitters and receivers can be represented as follows:

$$\begin{matrix}\begin{matrix}T ( t ) = A sin ( 2 π {f}_{0} ) \\ = {\sum }_{i = 1}^{{N}_{t , r}} {P}_{i} ( t )\end{matrix} & ( 1 ) \\ and & \\ R ( t ) = {\sum }_{i = 1}^{{N}_{t , r}} {R}_{i} ( t ) & ( 2 ) \\ where & \\ {P}_{i} ( t ) = {\sum }_{k = 1}^{{N}_{t , r}} {w}_{k} ( t ) T ( t ) and {\sum }_{k = 1}^{{N}_{t , r}} {w}_{k} ( t ) = 1 , ∀ t & ( 3 )\end{matrix}$$

where T(t) is the excitation function for the effectively moving transmitter, R(t) is the received signal due to the effectively moving transmitter and receiver, Pᵢ(t) is the pulse associated with the i-th transmitter, Rᵢ(t) is the received signal at the i-th transmitter and wₖ(t) is the weight associated with the i-th transmitter. Linear interpolation is used for the weights wₖ(t), and in some embodiments, at most two antennas radiate or receive at a time. A similar weighting scheme is used for embodiments with a single transmitter and single receiver, in which a specific filter (e.g., filters 1224 of FIG. 12) is used to obtain the received voltage for each different excitation from the received voltage associated with the impulse (UWB) excitation.

$${R}_{i} ( f ) = \frac{{P}_{i} ( f ) {U}_{i} ( f )}{{S}_{i} ( f )} \\ A ( f ) {{⇔}_{IFFT}}^{FFT} A ( t ) \qquad ( 4 )$$

In Equation (4), Sᵢ(f) is the UWB pulse spectrum used in the single-antenna case and Uᵢ(f) is the received signal due to Sᵢ(f), at measurement i. The Fourier transform is used to convert between frequency domain and time domain versions of the functions. The direction and speed of effective movement in a transmitter or receiver array can be adjusted independently. Thus, for instance, the transmitter array may be effectively moving down while the receiver array is effectively moving up. In some embodiments, the transmitter array may be effectively moving faster than the receiver array, particularly in cases where the transmitter array is longer than the receiver array.

The equation for the frequency that is observed at the receiver due to the transmitter and/or receiver moving is:

$${f}_{0} = {f}_{s} ( 1 + \frac{{\hat{r}}_{ts} \cdot {\vec{v}}_{s}}{{v}_{c}} ) ( 1 + \frac{{\hat{r}}_{to} \cdot {\vec{v}}_{o}}{{v}_{c}} ) \qquad ( 5 )$$

where • is the vector inner product, fₒ is the observed frequency, fₛ is source frequency, rₜₛ is source to target unit vector, rₜₒ is observer to target unit vector, vₛ is velocity of the transmitter, vₒ is velocity of the receiver, and v_{c} is the speed of waves in the subterranean environment.

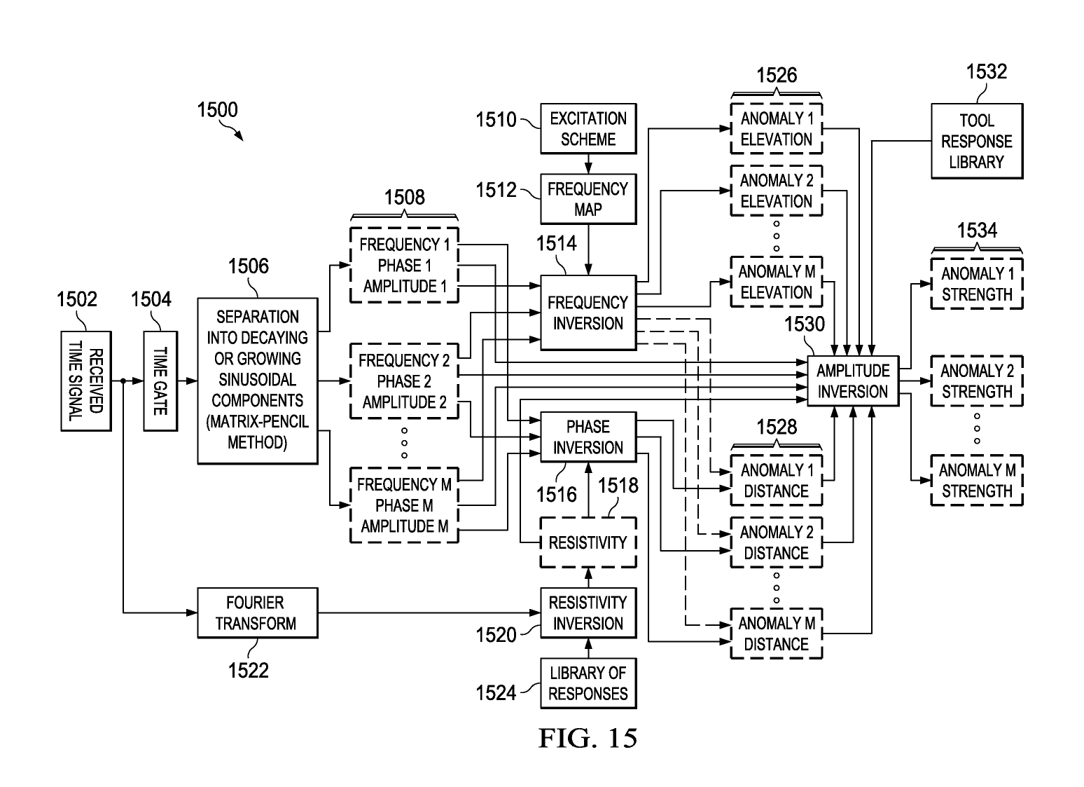

FIG. 15 is a data flow chart of an illustrative Doppler-enhanced inversion scheme 1500 for localization. The technique shown in FIG. 15 assumes that the anomaly being imaged is discrete (i.e., not of substantial volume) and can be sufficiently described with the anomaly's position and the reflection intensity of signals received from the anomaly. The scheme 1500 may be used to process signals and obtain information pertaining to any number of anomalies. The first step in implementing scheme 1500 is to process signals from receive antennas as shown in Equations (1)-(4), thus resulting in a received time signal (block 1502). The received signal is then passed through a time gate 1504 that selects only a portion of the received signal at which antennas are effectively moving and initial transients have died out. This signal contains sums of signals originating from different anomalies, where each anomaly has a different frequency signature and thus contributes as a different frequency. At block 1506, a Matrix-Pencil or similar method is used to separate the signal into decaying or growing exponential components. The result 1508, as shown in FIG. 15, is that several signals are separated, each by its frequency, phase and amplitude. Each frequency corresponds to a different anomaly.

The frequencies produced at 1508 are used in a frequency inversion process (block 1514). The phases are used in a phase inversion process (block 1516). The amplitudes are used in an amplitude inversion process (block 1530). Each of these inversion processes receives several inputs that are used in performing that particular inversion process. Specifically, to perform the frequency inversion 1514, an excitation scheme 1510 and frequency map 1512 are used. Performing the frequency inversion 1514 produces the depth of each anomaly (blocks 1526). Excitation scheme 1510 is composed of the transmitter and receiver positions and the manner in which they imitate antenna movement (e.g., imitated movement start point, speed, imitated movement end point). Given the excitation scheme 1510, a frequency map 1512 may be calculated as described by Equation (5). Inversion is performed by searching for an anomalous position (e.g., distance and elevation) that produces the set of frequencies 1508. This search may be performed using a pre-constructed look up table. The search may also be a gradient-based search in which a cost function composed of frequency, phase and amplitude values is minimized to obtain the position that achieves the minimum residual. Such inversion algorithms are known to those skilled in the art.

To perform the phase inversion 1516, a library of responses 1524 and a Fourier transform 1522 of the received time signal are first used to perform a resistivity inversion 1520. Performing the resistivity inversion 1520 produces a resistivity 1518, which is used to perform the phase inversion 1516. Performing the phase inversion 1516 produces the horizontal distance of each anomaly from the receiver array (block 1528). Resistivity inversion 1520 uses the library of responses 1524 and the Fourier-transformed, received signal to find the resistivity 1518 that corresponds to the given received signal in the library of responses 1524. The library of responses 1524 can be pre-constructed through the use of electromagnetic modeling methods on a large set of resistivity values 1518. Such inversion algorithms are known to those skilled in the art.

The amplitude inversion 1530 is performed using the amplitude values 1508, resistivity values 1518, and tool response library 1532. Anomaly depths 1526 and anomaly horizontal distance 1528 also are used to perform the amplitude inversion 1530. Performing the amplitude inversion 1530 produces a strength value for each of the anomalies (blocks 1534). Amplitude inversion 1530 searches the tool response library 1532 to find the anomaly strengths 1534 that match the values in the tool response library for the given amplitudes 1508. Tool response library 1532 may be constructed through the use of electromagnetic modeling methods on a large set of anomaly strengths 1534. Such inversion algorithms are known to those skilled in the art. In acoustic/seismic embodiments, a velocity inversion process is performed in lieu of the resistivity inversion 1520. The velocity inversion process has the same inputs as the resistivity inversion 1520 but produces a different output—namely, compression and shear velocity values in lieu of resistivity values 1518. Specifically, acoustic impedance is a product of rock density and wave velocity. An impedance inversion using a known density (or a density assumed to be constant) produces wave velocity. The produced wave velocities may include compressional and shear wave velocities.

In some embodiments, the technique described with respect to FIG. 15 may be iteratively performed in the same environment. For example, referring simultaneously to FIGS. 4 and 15, drilling may be halted so that the drill string 404 is not moving and the single transmitter 408 is in a position Z₁. The array of receivers 410 may be sequentially activated from R₁ to R_{M}, R_{M} to R₁, or both to obtain a set of data for the transmitter position Z₁. This set of data may be processed as described in FIG. 15 to produce frequency, phase and amplitude values 1508 corresponding to transmitter position Z₁. Drilling may then resume for a period of time until the single transmitter 408 is in a position Z₂, at which point the array of receivers 410 is activated to obtain data that is processed as described in FIG. 15 to produce frequency, phase and amplitude values 1508 for transmitter position Z₂. This process may be iteratively performed for a plurality of positions Z₁, Z₂, . . . , Z_{N}, with each iteration producing frequency, phase and amplitude values 1508. The set of values 1508 are then processed together using various inversion techniques as described with respect to FIG. 15 to produce the anomaly elevation values 1526, anomaly distance values 1528, and anomaly strength values 1534.

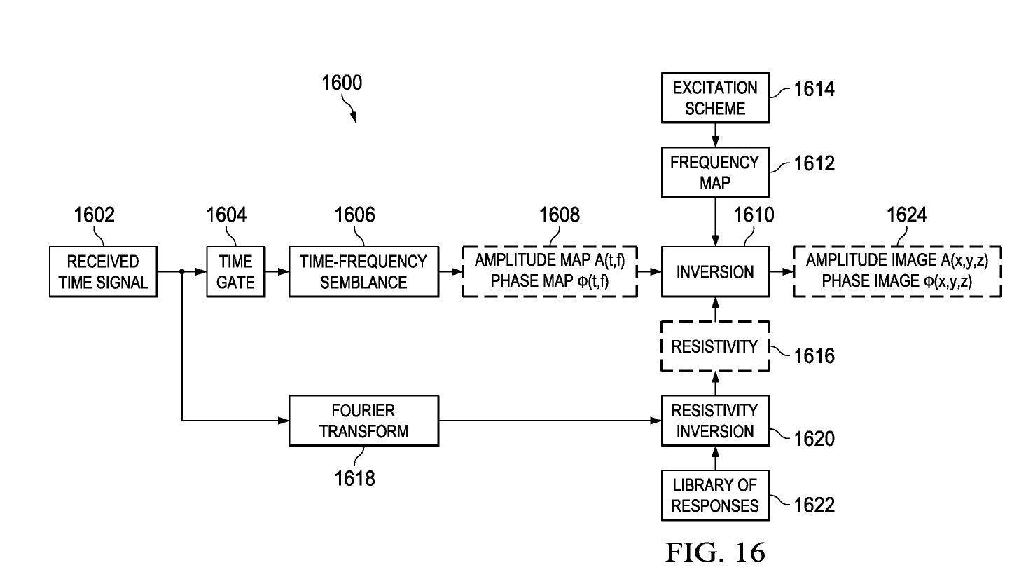

FIG. 16 is a data flow chart of an illustrative Doppler-enhanced inversion scheme 1600 for imaging. The scheme 1600 is an imaging method useful in embodiments wherein the anomaly to be imaged is volumetrically distributed. The scheme described in FIG. 15 may be used to obtain an image that includes a set of points, while the scheme in FIG. 16 may be used to obtain a two-dimensional image. The former is useful in cases where anomalies may be assumed to be small and point-like (e.g., small reservoirs), and the latter is useful for volumetric anomalies (e.g., large reservoirs). The first step in implementing scheme 1600 is to process signals from receive antennas as shown in Equations (1)-(4), thus resulting in a received time signal (block 1602). The received signal is then passed through a time gate 1604 that selects only a portion of the received signal at which antennas are effectively moving and initial transients have died out. This signal contains sums of signals originating from different anomalies, where each anomaly has a different frequency signature and thus contributes as a different frequency. The scheme 1600 then entails obtaining a time-domain response transmitters/receivers used to transmit and receive the signal(s) being processed. The time response is processed by a time-frequency semblance (block 1606) or short-time Fourier transform algorithm that produces an amplitude value A (t,f) that indicates amplitude of frequency f content in the vicinity of time t (block 1608). Similarly, it produces a phase value Φ(t,f) that indicates phase of frequency f content in the vicinity of a time t (block 1608). This amplitude and phase information, coupled with frequency map information (block 1612) determined using the excitation scheme (block 1614), and further coupled with resistivity information (block 1616) calculated using the resistivity inversion process (block 1620) that is determined using the library of responses (block 1622) and Fourier transform (block 1618) of the received signals, is used to perform an inversion (block 1610). The inversion at block 1610 is performed using Equation (5). The result of the inversion performance is an amplitude image A (x,y,z) and a phase image Φ(x,y,z). The amplitude image may be used as an indication of anomaly distribution in space. The phase may be further converted to additional information about the anomaly—for instance and without limitation, the phase may indicate an acoustic impedance anomaly. In acoustic/seismic embodiments, the resistivity inversion process (block 1620) is replaced by a velocity inversion process and resistivity values (block 1616) are replaced by compressional and shear velocity information. These values are calculated as explained above with respect to FIG. 15. Further, the iterative process described above with respect to FIG. 15 may also be used with respect to the technique shown in FIG. 16—that is, multiple values 1608 are obtained based on data from multiple, discrete single transmitter positions Z₁, Z₂, . . . , Z_{N}, and the multiple values 1608 are then processed together to obtain an amplitude and phase image 1624.

FIG. 17 is a process flow chart of an illustrative Doppler-enhanced visualization method 1700. Method 1700 begins by providing a first measurement unit in a well (step 1702). As explained above, a measurement unit may be a single transmitter or receiver or an array of transmitters or receivers. When deployed downhole, the measurement unit may be housed on or within a wireline sonde, a drill string, a casing string or a cement sheath. The method 1700 then comprises providing a second measurement unit outside of the well (step 1704). For instance, the second measurement unit may be disposed on or near the Earth's surface, on a motor vehicle or boat, on the ocean floor, or in a different well. The method 1700 also comprises providing signals between the first and second measurement units (step 1706). The signals may be transmitted and received under a wide variety of schemes, many of which were described above (e.g., with respect to FIGS. 3-9). The method 1700 next comprises effectively moving the first and/or second measurement units during the transmission of signals (step 1708). As explained, “effective movement” means either actual, physical movement of a transmitter or receiver (e.g., movement of a transmitter disposed on a drill string by drilling deeper into a borehole with that drill string) or movement that is simulated using an array of transmitters or receivers (e.g., by sequentially activating each component in the array). Finally, the method 1700 comprises using signals incident upon an anomaly to visualize or collect information about the anomaly (step 1710). This step includes processing the received signals as explained above with respect to FIGS. 15 and/or 16. The steps of method 1700 are merely intended to represent the general technique used herein at a high level, and they should be interpreted in light of the discussion provided above. The scope of disclosure is not limited to the precise steps disclosed in the method 1700, and method 1700 may be modified in any suitable fashion, such as by adding, deleting or rearranging steps.

Numerous other variations and modifications will become apparent to those skilled in the art once the above disclosure is fully appreciated. It is intended that the following claims be interpreted to embrace all such variations, modifications and equivalents. In addition, the term “or” should be interpreted in an inclusive sense.

The present disclosure encompasses numerous embodiments. At least some of these embodiments are directed to a system to obtain information about a subsurface formation that comprises an array of acoustic transmitters in a first well; a distributed acoustic sensing (DAS) fiber in a second well; and processing logic, in communication with the array of acoustic transmitters and the DAS fiber, that activates the array of acoustic transmitters and the DAS fiber so as to use the Doppler effect to obtain information about the subsurface formation. Such embodiments may be supplemented in a variety of ways, including by adding any of the following concepts in any sequence and in any combination: to use the Doppler effect, the processing logic selectively activates each acoustic transmitter in the array of acoustic transmitters; to use the Doppler effect, the processing logic applies a weighting technique to signals to be transmitted by the array of acoustic transmitters; to use the Doppler effect, the processing logic applies a weighting technique to signals received by way of the DAS fiber; a second DAS fiber in communication with the processing logic, and wherein the processing logic uses the second DAS fiber to visualize the subsurface formation; the array of acoustic transmitters and the DAS fiber are associated with a configuration selected from the group consisting of a monopole, a dipole and a quadrupole; the processing logic generates an image of the subsurface formation using parameters comprising: a frequency of a seismic signal received by the DAS fiber, a frequency of a seismic signal transmitted by the array of acoustic transmitters, an acoustic transmitter-to-formation unit vector, and a DAS fiber-to-formation unit vector.

At least some embodiments are directed to a system for imaging a subsurface formation that comprises an acoustic transmitter, positioned in a well, to transmit signals toward the subsurface formation; a distributed acoustic sensing (DAS) fiber located outside of said well to receive signals incident upon said subsurface formation; and processing logic in communication with the acoustic transmitter and the DAS fiber, wherein the processing logic causes the acoustic transmitter to effectively move during transmission of said signals, and wherein the processing logic uses the received signals to generate an image of said subsurface formation. Such embodiments may be supplemented in a variety of ways, including by adding any of the following concepts in any sequence and in any combination: another DAS fiber located outside of said well to receive signals incident upon the subsurface formation, and wherein the processing logic uses the signals received at the DAS fiber and at the another DAS fiber to generate said image; the processing logic causes the acoustic transmitter to move within the well during transmission of said signals, and wherein the system comprises an array of receivers external to the well to receive said signals incident upon the subsurface formation; the processing logic causes the array of receivers to receive said signals incident upon the subsurface formation in a sequential manner; the processing logic assigns a weight to signals received by each of the receivers in said array; the processing logic assigns a weight to each of multiple signals received from the DAS fiber; the DAS fiber has a location selected from the group consisting of: another well, a surface of the Earth, a boat, a motor vehicle, and the ocean floor; the processing logic generates the image of the subsurface formation using parameters comprising: a frequency of a seismic signal received by the DAS fiber, a frequency of a seismic signal transmitted by the acoustic transmitter, an acoustic transmitter-to-formation unit vector, and a DAS fiber-to-formation unit vector; each of said acoustic transmitter and DAS fiber has an arrangement selected from the group consisting of monopoles, dipoles and quadrupoles; the transmitted and received signals are acoustic or seismic signals.

At least some of the embodiments are directed to a method to obtain information about a subsurface formation that comprises providing a measurement unit; providing a distributed acoustic sensing (DAS) fiber; providing signals between the measurement unit and the DAS fiber, at least some of said signals incident upon the subsurface formation; during said provision of signals, effectively moving the measurement unit; and using said signals incident upon the subsurface formation to obtain information pertaining to the subsurface formation. Such embodiments may be supplemented in a variety of ways, including by adding any of the following concepts or steps in any sequence and in any combination: said measurement unit is selected from the group consisting of a single transmitter and an array of transmitters; effectively moving the measurement unit comprises using the Doppler effect to obtain said information pertaining to the subsurface formation; and wherein the measurement unit is a single transmitter, and further comprising: providing at least some of said signals from the single transmitter to the DAS fiber at a first single transmitter position; providing at least some of said signals from the single transmitter to the DAS fiber at a second single transmitter position; obtaining first frequency, phase and amplitude values based on said signals transmitted at the first single transmitter position; obtaining second frequency, phase and amplitude values based on said signals transmitted at the second single transmitter position; and using multiple inversion techniques to obtain image or location information pertaining to the subsurface formation based on both the first and second frequency, phase and amplitude values.

What is claimed is:

1. A system to obtain information about a subsurface formation, comprising:
an array of acoustic transmitters in a first well;
a distributed acoustic sensing (DAS) fiber in a second well; and
processing logic, in communication with the array of acoustic transmitters and the DAS fiber, that activates the array of acoustic transmitters and the DAS fiber so as to use the Doppler effect to obtain information about the subsurface formation.

2. The system of claim 1, wherein, to use the Doppler effect, the processing logic selectively activates each acoustic transmitter in the array of acoustic transmitters.

3. The system of claim 1, wherein, to use the Doppler effect, the processing logic applies a weighting technique to signals to be transmitted by the array of acoustic transmitters.

4. The system of claim 1, wherein, to use the Doppler effect, the processing logic applies a weighting technique to signals received by way of the DAS fiber.

5. The system of claim 1, further comprising a second DAS fiber in communication with the processing logic, and wherein the processing logic uses the second DAS fiber to visualize the subsurface formation.

6. The system of claim 1, wherein the array of acoustic transmitters and the DAS fiber are associated with a configuration selected from the group consisting of a monopole, a dipole and a quadrupole.

7. The system of claim 1, wherein the processing logic generates an image of the subsurface formation using parameters comprising: a frequency of a seismic signal received by the DAS fiber; a frequency of a seismic signal transmitted by the array of acoustic transmitters; an acoustic transmitter-to-formation unit vector; and a DAS fiber-to-formation unit vector.

8. A system for imaging a subsurface formation, comprising:
an acoustic transmitter, positioned in a well, to transmit signals toward the subsurface formation;
a distributed acoustic sensing (DAS) fiber located outside of said well to receive signals incident upon said subsurface formation; and
processing logic in communication with the acoustic transmitter and the DAS fiber,
wherein the processing logic causes the acoustic transmitter to effectively move during transmission of said signals, and
wherein the processing logic uses the received signals to generate an image of said subsurface formation.

9. The system of claim 8, further comprising another DAS fiber located outside of said well to receive signals incident upon the subsurface formation, and wherein the processing logic uses the signals received at the DAS fiber and at the another DAS fiber to generate said image.

10. The system of claim 8, wherein the processing logic causes the acoustic transmitter to move within the well during transmission of said signals, and wherein the system comprises an array of receivers external to the well to receive said signals incident upon the subsurface formation.

11. The system of claim 10, wherein the processing logic causes the array of receivers to receive said signals incident upon the subsurface formation in a sequential manner.

12. The system of claim 10, wherein the processing logic assigns a weight to signals received by each of the receivers in said array.

13. The system of claim 8, wherein the processing logic assigns a weight to each of multiple signals received from the DAS fiber.

14. The system of claim 8, wherein the DAS fiber has a location selected from the group consisting of: another well; a surface of the Earth; a boat; a motor vehicle; and the ocean floor.

15. The system of claim 8, wherein the processing logic generates the image of the subsurface formation using parameters comprising: a frequency of a seismic signal received by the DAS fiber; a frequency of a seismic signal transmitted by the acoustic transmitter; an acoustic transmitter-to-formation unit vector; and a DAS fiber-to-formation unit vector.

16. The system of claim 8, wherein each of said acoustic transmitter and DAS fiber has an arrangement selected from the group consisting of monopoles, dipoles and quadrupoles.

17. The system of claim 8, wherein the transmitted and received signals are acoustic or seismic signals.

18. A method to obtain information about a subsurface formation, comprising:
providing a measurement unit;
providing a distributed acoustic sensing (DAS) fiber;
providing signals between the measurement unit and the DAS fiber, at least some of said signals incident upon the subsurface formation;
during said provision of signals, effectively moving the measurement unit; and
using said signals incident upon the subsurface formation to obtain information pertaining to the subsurface formation.

19. The method of claim 18, wherein said measurement unit is selected from the group consisting of a single transmitter and an array of transmitters.

20. The method of claim 18, wherein effectively moving the measurement unit comprises using the Doppler effect to obtain said information pertaining to the subsurface formation.

21. The method of claim 18, wherein the measurement unit is a single transmitter, and further comprising:
providing at least some of said signals from the single transmitter to the DAS fiber at a first single transmitter position;
providing at least some of said signals from the single transmitter to the DAS fiber at a second single transmitter position;
obtaining first frequency, phase and amplitude values based on said signals transmitted at the first single transmitter position;
obtaining second frequency, phase and amplitude values based on said signals transmitted at the second single transmitter position; and
using multiple inversion techniques to obtain image or location information pertaining to the subsurface formation based on both the first and second frequency, phase and amplitude values.
